(19) United States
(12) Patent Application Publication
(10) Pub. No.: US 2018/0187019 A1
(43) Pub. Date: Jul. 5, 2018

(54) COATED ALKALINE EARTH METAL CARBONATES AND THEIR USES

(71) Applicant: Imerys Minerals Limited, Par Cornwall (GB)

(72) Inventors: Steve DUNN, Congleton Cheshire (GB); Douglas WICKS, John Creek, GA (US); Virendra SINGH, Cumming, GA (US)

(21) Appl. No.: 15/736,310

(22) PCT Filed: Aug. 12, 2016
(86) PCT No.: PCT/GB2016/052513

§ 371 Date: Dec. 14, 2017

Related U.S. Application Data
(60) Provisional application No. 62/205,391, filed on Aug. 14, 2015.

(30) Foreign Application Priority Data
Aug. 14, 2015 (GB) 1514458.7

(51) Int. Cl. C09C 1/02; C08K 9/04; C08K 3/26; C09D 11/037

(52) U.S. Cl. CPC C09C 1/021; C08K 9/04; C08K 3/26; C09D 11/037; C08K 2201/006; C01P 2004/61; C01P 2006/12; C08K 2003/265; C08K 2201/003; C01P 2004/62

(57) ABSTRACT

The present invention relates to alkaline earth metal carbonate particles comprising a coating of aliphatic carboxylic acids and/or their salts, and their use as fillers in plastic materials or as extenders in offset ink.

### FIELD OF THE INVENTION

The present invention relates to coated alkaline earth metal carbonates, such as coated calcium carbonates and their uses. For example, the invention relates to coated ground (natural) alkaline earth metal carbonates, such as coated calcium carbonates and coated precipitated (artificial) alkaline earth metal carbonates, such as coated calcium carbonates and their uses, having one or more coatings of one or more carboxylic acids, such as for example one or more branched carboxylic acids having at least one alkyl chain, and/or one or more cycloaliphatic acids, and/or their salts.

### BACKGROUND OF THE INVENTION

Alkaline earth metal carbonates, such as, for example, calcium carbonate and magnesium carbonate, may often be combined with other compositions in order to act as modifiers to provide different properties to the compositions and/or to act as fillers to reduce the amount of more expensive materials included in the compositions. However, some properties of the alkaline earth metal carbonates may render them less compatible than desired with the compositions, such as, for example, polymers used in polymer processing to make polymer products. As a result, it may be desirable to modify the surface properties of the alkaline earth metal carbonate particulates so that they are more easily integrated into other compositions.

One example of surface treatment of alkaline earth metal carbonates is treatment with long chain fatty acids, such as, for example, stearic acid. Such surface treatment improves the compatibility of the treated particulates with, for example, polymers and other compositions. However, there is a desire to reduce the amount and/or cost of such surface treatments. For example, in order to treat particulates with stearic acid, it may be necessary to heat the mixture of stearic acid and particulates to a temperature greater 100° C. This heating requires energy that increases the cost of the surface treatment. In addition, surface treatment with fatty acids such as stearic acid may require a relatively large amount of stearic acid to achieve the desired surface properties of the treated particulates. Furthermore, surface treatment with stearic acid may result in the presence of volatiles in the surface treated particulates that may adversely affect processing of the composition into which the treated particulates are added, such as, for example, polymers processed at relatively higher temperatures.

Coated mineral particles are known in the art for various uses and applications.

EP 2 159 258 A1 discloses coated mineral fillers such as calcium carbonates, wherein the coating is a mixture of at least one saturated C₈ to C₂₄ aliphatic carboxylic acid and a di- and/or trivalent cation salt of one or more saturated C₈ to C₂₄ aliphatic carboxylic acids, wherein the weight ratio of salt to acid is from 51:49 to 75:25. These particles are claimed to have reduced volatiles content, but there is no information on their performance as filler materials, nor on the mechanical properties of the finished cured thermoplastic materials.

US 2006/0042511 A1 and US 2006/0046058 A1 both disclose coated pigment particles, wherein the particles are coated with at least one ester or partial ester of an organic polyol and with a hydroxyl-group functionalised saturated fatty acid. It is claimed that the coated pigments have improved dispersability and processability in thermoplastic materials. There is no information on their performance as filler materials, nor on the mechanical properties of the finished cured thermoplastic materials.

US 2009/0099285 A1 discloses high surface area precipitated calcium carbonate particles with at least one coating agent selected from the group consisting of fatty acids, optionally substituted with a hydroxy group; organic sulfonic acids, alkylsulfates, and the salts thereof. These particles are claimed to improve the rheology of polyvinyl chloride, but there is no indication of the mechanical properties of the finished cured plastic materials.

There is a constant requirement for providing plastic materials with improved mechanical properties at reduced cost. One possibility to influence the mechanical properties of a plastic material is the use of filler materials that may have an effect on the said properties. The prior art therefore constitutes a problem.

As a result of the above, it may be desirable to develop different surface treatment compositions and/or methods for surface treatment of particulates that reduce the costs of the surface treatment and/or provide more desirable post-treatment properties. The compositions and methods disclosed herein may address one or more of these goals.

### SHORT DESCRIPTION OF THE INVENTION

The present invention is defined in the appended claims. In the following description, certain aspects and embodiments will become evident, It should be understood that the aspects and embodiments, in their broadest sense, could be practiced without having one or more features of these aspects and embodiments. It should be understood that these aspects and embodiments are merely exemplary.

In particular, the present invention is embodied by an alkaline earth metal carbonate particle, such as a calcium carbonate particle, comprising a coating of one or more aliphatic carboxylic acids, salts thereof, or a mixture of one or more aliphatic carboxylic acids and one or more of their salts. It has been found that such particles have unexpected beneficial properties, for example as fillers in plastic materials, or extenders or stabilising agents in offset inks.

According to one aspect of the present invention, the said one or more aliphatic carboxylic acids may be selected from one or more cycloaliphatic acids, or from one or more branched carboxylic acids having at least one alkyl chain, or from one or more fatty acids, or from one or more hydroxylated fatty acids.

According to one aspect of the present invention, the calcium carbonate particle may be a ground (natural) alkaline earth metal carbonate, or a precipitated (artificial) alkaline earth metal carbonate, such as for example a ground calcium carbonate (GCC) or a precipitated calcium carbonate (PCC), or a ground magnesium carbonate or a precipitated magnesium carbonate.

According to one aspect of the present invention, the coating on the alkaline earth metal carbonate is a monolayer coating. It was found that the above advantages are particularly noticeable in the case of monolayer coatings. According to further aspects of the present invention, the said coating may be present in less than a monolayer concentration, or the said coating may be present in a concentration greater than a monolayer concentration.

According to one aspect of the present invention, the coating on the alkaline earth metal carbonate constitutes from 0.05 wt.-% to 5 wt.-% of the total particle, including the coating, such as for example from 0.1 wt.-% to 5 wt.-%, or from 0.1 wt.-% to 4 wt.-%, or from 0.1 wt.-% to 3 wt.-%, or from 0.1 wt.-% to 2 wt.-%, or from 0.1 wt %.-% to 1.0 wt.-%, or from 0.1 wt.-% to 0.9 wt.-%, or from 0.1 wt.% to 0.8 wt.-%, or from 0.1 wt.-% to 0.7 wt.-%, or from 0.1 wt.-% to 0.6 wt.-%, or from 0.1 wt.-% to 0.5 wt.-%, or from 0.1 wt.-% to 0.4 wt.-%, or from 0.2 wt.-% to 0.6 wt.-%.

According to one aspect of the present invention, the coating on the alkaline earth metal carbonate, such as the calcium carbonate, is one or more fatty acids, and/or one or more hydroxylated fatty acids and/or one or more of their salts. It was found that fatty acids and hydroxylated fatty acids displayed particular advantages for specific used of the calcium carbonate particle. The said one or more fatty acids, according to one aspect of the invention, may be selected from C₈ to C₃₂-fatty acids and hydroxylated C₈ to C₃₂-fatty acids, as well as their salts. In particular, they may be selected from stearic acid, palmitic acid, myrisitc acid, lauric acid, their hydroxylated derivatives, any mixtures thereof, and their salts, including mixtures of salt and acid forms.

According to one aspect of the present invention, the one or more aliphatic carboxylic acids is one or more optionally hydroxylated stearic acids, such as for example 12-hydroxystearic acid.

According to one aspect of the present invention, the said one or more aliphatic carboxylic acids is one or more cycloaliphatic acids comprising at least one of a five carbon ring and a six carbon ring, and a combination of both five carbon ring and six carbon ring cycloaliphatic acids. For example, the said cycloaliphatic acid may comprise at least one of naphthenic acid, 7-(3-butylcyclopentyl)heptanoic acid, 7-(3-propylcyclopentyl)heptanoic acid, 7-(3-vethylcyclopentyl)heptanoic acid, 6-(1-butyloctahydro-1H-inden-5-yl)hexanoic acid, 6-(4-butyloctahydropentalen-2-yl)hexanoic acid, and 7-(5-butyldodecahydro-1H-phenalen-2-yl)heptanoic acid. It was found that these presented certain advantages.

According to one aspect of the present invention, the said one or more aliphatic carboxylic acids is one or more branched carboxylic acids having at least one alkyl chain (e.g. an alkyl chain forming a branch), for example comprising at least one of 2-ethylhexanoic acid, isostearic acid, alkyl-substituted cyclohexane carboxylic acid, and crystalline diacids. It was found that these presented certain advantages.

According to one aspect of the present invention, the alkaline earth metal carbonate, particle consists of an alkaline earth metal carbonate, such as a calcium carbonate, and one or more aliphatic carboxylic acids, one or more salts thereof, or a mixture of one or more aliphatic carboxylic acids and one or more of their salts only, that is to say that no substantial or detectable amounts of other substances, such as other minerals or other organic or inorganic coatings are present. It was found that the “pure” coated alkaline earth metal carbonates, such as the calcium carbonates, gave best results for certain applications.

According to one aspect of the present invention, the ground alkaline earth metal carbonate, such as ground calcium carbonate, has no other coatings present on the particle surface. It was found that the advantages of the aliphatic carboxylic acids, their salts, or mixtures of aliphatic carboxylic acids and one or more of their salts are best obtained when no other coatings are present.

According to one aspect of the present invention, the coating of aliphatic carboxylic acid(s), one or more of their salts, or a mixture of aliphatic carboxylic acid(s) and one or more of their salts is applied directly onto the particle surface, that is to say no other coatings, or no other composition is present between the calcium carbonate particle surface and the coating of aliphatic carboxylic acid(s), one or more of their salts, or a mixture of aliphatic carboxylic acid(s) and one or more of their salts. It was found that the coating of the particle was particularly effective when applied directly onto the particle surface.

According to one aspect of the present invention, a separate coating is present on the alkaline earth metal carbonate particle, such as the calcium carbonate particle, such as for example between the coating of aliphatic carboxylic acid(s), one or more salts thereof, or a mixture of aliphatic carboxylic acid(s) and one or more of their salts, and the particle, or for example on top of a coating of aliphatic carboxylic acid(s), one or more salts thereof, or a mixture of aliphatic carboxylic acid(s) and one or more of their salts, applied directly onto the particle surface, or both. It was found that various such embodiments present various advantages, depending on the application.

According to one aspect of the present invention, the alkaline earth metal carbonate particle, such as the calcium carbonate particle, has a particle size distribution such that the d₅₀ is between 0.05 μm and 20 μm, for example between 0.05 μm and 10 μm, or between 0.1 μm and 5 μm, or between 0.25 μm and 2.5 μm, or between 0.4 μm and 1 μm, or such as for example about 0.2 μm, or about 0.4 μm, or about 0.6 μm, or about 0.8 μm, or about 1.0 μm, or about 1.5 μm, or about 2.0 μm. It was found that various such embodiments present various advantages, depending on the application.

According to one aspect of the present invention, the alkaline earth metal carbonate particle, such as the calcium carbonate particle, has a mass ratio of ground calcium carbonate to aliphatic carboxylic acid(s) and their salt(s) is from 1000:1 to 1:1, such as for example from 500:1 to 10:1, or from 250:1 to 25:1, or from 200:1 to 50:1, or from 150:1 to 75:1, such as for example about 10:1, or about 20:1, or about 40:1, or about 60:1, or about 70:1, or about 80:1, or about 100:1, or about 125:1, or about 150:1, or about 200:1, or about 250:1, or about 500:1, or about 1000:1. It was found that various such embodiments present various advantages, depending on the application.

According to one aspect of the present invention, the alkaline earth metal carbonate particle, such as the calcium carbonate particle, prior to application of the coating, has a BET surface area of 0.4 to less than 50 m²·g⁻¹. For example, the calcium carbonate particle, prior to application of the coating, may a BET surface area of 0.46 to 45 m²·g⁻¹, such as for example from 0.5 to 40 m²·g⁻¹, or from 0.75 to 35 m²·g⁻¹, or from 1.0 to 30 m²·g⁻¹, or from 2.0 wt % to 25 m²·g⁻¹, or from 3.0 to 20 m²·g⁻¹, or from 4.0 to 16 m²·g⁻¹, or from 5.0 to 10 m²·g⁻¹, such as for example about 1.0 m²·g⁻¹, or about 2.0 m²·g⁻¹, or about 3.0 m²·g⁻¹, or about 4.0 m²·g⁻¹, or about 5.0 m²·g⁻¹, or about 6.0 m²·g⁻¹, or about 7.0 m²·g⁻¹, or about 8.0 m²·g⁻¹, or about 9.0 m²·g⁻¹, or about 10 m²·g⁻¹, or about 11 m²·g⁻¹, or about 12 m²·g⁻¹, or about 13 m²·g⁻¹, or about 14 m²·g⁻¹, or about 15 m²·g⁻¹, or about 16 m²·g⁻¹.

According to one aspect of the present invention, the alkaline earth metal carbonate particle, such as the calcium carbonate particle, may be used as a filler in a plastic material. It was found that the particles according to the present invention were specifically suited for use as fillers in plastic materials in order to improve their mechanical properties, such as scratch resistance thermal conductivity during curing or reduced shrinkage.

According to one aspect of the present invention, the plastic material may be polyurethane. According to this aspect the coated alkaline earth metal carbonate particles, such as the coated ground calcium carbonate particles may be dispersed in a polyol component of a 2-component polyol/isocyanate system prior to mixing the components for forming the polyurethane. It was found that according to this use, the mechanical properties of polyurethane could be particularly improved.

According to one aspect of the present invention, the plastic material comprising the alkaline earth metal carbonate, such as the calcium carbonate, of the present invention is employed for example as a furniture lacquer, or as a flexible foam, or as a flooring top coat and/or as a cast or moulded plastic article. It was found that the improved mechanical characteristics beneficially applied to these products.

According to one further aspect of the present invention, the alkaline earth metal carbonate particle, such as the calcium carbonate particle, may be used as an additive in an offset ink. It was found that the use of the coated calcium carbonates according to the present invention leads to an improved ink/water balance in offset printing and reduced bleeding of ink into fountain solution.

According to one further aspect of the present invention, the alkaline earth metal carbonate particle, such as the calcium carbonate particle, may be part of or may constitute a filler composition. According to one embodiment of the present invention, the said filler composition may be comprised in a polymer composition. According to one further embodiment of the present invention, the alkaline earth metal carbonate particle according to the invention, such as the calcium carbonate particle, may be included in a polymer composition. According to a further aspect of the present invention, the said polymer composition may comprise at least one of a molded polymer product, an extruded polymer product, a polymer fiber, a polymer nonwoven, and a polymer film. According to one further aspect of the present invention, the alkaline earth metal carbonate particles, such as the calcium carbonate particles, or filler compositions, may be for use in other compositions, such as, for example, compositions including polymer resins. According to some embodiments, the alkaline earth metal carbonate particles or filler composition are for use in other compositions, except compositions related to paper or compositions for use in paper, for example, as filler, a pigment, or a coating for paper.

Also part of the present invention is a method of making alkaline earth metal carbonate particles according to the present invention, the method comprising the steps of providing an alkaline earth metal carbonate, providing one or more aliphatic carboxylic acids, salts thereof, or a mixture of one or more aliphatic carboxylic acids and one or more of their salts, and contacting the said alkaline earth metal carbonate with the said one or more aliphatic carboxylic acids, the salts thereof, or the said mixture of one or more aliphatic carboxylic acids and one or more of their salts, for example at a temperature equal to or less than 150° C.

Also part of the present invention is a method of surface treating alkaline earth metal carbonate particles, the method comprising providing an alkaline earth metal carbonate, combining one or more aliphatic carboxylic acids, salts thereof, or a mixture of one or more aliphatic carboxylic acids and one or more of their salts, with the said alkaline earth metal carbonate, and for example, heating the obtained combination to a temperature equal to or less than 150° C. to form a coating of the said one or more aliphatic carboxylic acids, salts thereof, or a mixture of one or more aliphatic carboxylic acids and one or more of their salts on the alkaline earth metal carbonate.

Also part of the present invention is a composition comprising or consisting of the coated alkaline earth metal carbonate particles disclosed herein, wherein an amount of the coating composition for achieving a monolayer ranges from 25 wt.-% to 75 wt.-% of the amount of stearic acid for achieving a monolayer.

It is understood that the following detailed description concerns exemplary embodiments of the present invention and shall not be limiting the scope of the invention as defined in the claims.

### BRIEF DESCRIPTION OF THE DRAWINGS

The accompanying drawings, which are incorporated in and constitute a part of this description, illustrate exemplary embodiments and together with the description, serve to explain principles of the embodiments.

FIG. 1 is a diagram showing a comparison between an exemplary untreated alkaline earth metal carbonate, the exemplary alkaline earth metal carbonate treated with stearic acid to form a crystalline coating, and the exemplary alkaline earth metal carbonate treated with an exemplary embodiment of a surface treatment (coating) composition.

FIG. 2 is a graph showing percent moisture pick-up (% MPU) as a function of percent of exemplary naphthenic acids (% w/w) for exemplary particulates having a median particle size (d₅₀) of 3 microns.

FIG. 3 is a graph showing percent moisture pick-up (% MPU) as a function of percent of exemplary naphthenic acids (% w/w) for exemplary particulates having a median particle size (d₅₀) less than 2 microns.

### DETAILED DESCRIPTION OF THE INVENTION

The present invention according to the appended claims provides coated alkaline earth metal carbonate particles, such as coated calcium carbonate particles for use in various applications. The terms “coating” and “surface treatment” and “surface treatment composition” may be used interchangeably throughout the present application. The use of aliphatic carboxylic acids and/or their salts, such as cycloaliphatic acids, and/or branched carboxylic acids comprising at least one alkyl chain and/or one or more fatty acids, and/or one or more hydroxylated fatty acids and/or one or more of their salts, for example hydroxylated stearic acid derivatives, for example 12-hydroxystearic acid as a coating, or for example the use of 12-hydroxystearic acid as the only coating, is particularly advantageous in the use of alkaline earth metal carbonate particles, such as the calcium carbonates as a filler in polyurethane, or as an extender in offset ink compositions. For example, coated ground calcium carbonate (GCC) may be used as a filler in polyurethane, or coated precipitated calcium carbonate (PCC) may be used in offset inks.

According to some embodiments, a composition may include a matrix material including an alkaline earth metal carbonate treated with a surface treatment composition. The surface treatment composition may include at least one of a cycloaliphatic acid and a branched carboxylic acid having at least one alkyl chain (e.g., an alkyl chain forming a branch). According to some embodiments, the matrix material may include a composition for use in other compositions, such as, for example, compositions including polymer resins. According to some embodiments, the matrix material may include a composition for use in other compositions, except compositions related to paper or compositions for use in paper, for example, as a filler, a pigment, or a coating for paper.

According to some embodiments, the composition may be a filler composition including an alkaline earth metal carbonate treated with a surface treatment composition. According to some embodiments, the surface treatment composition may include at least one of a cycloaliphatic acid and a branched carboxylic add having at least one alkyl chain (e g., an alkyl chain forming a branch). According to some embodiments, the branched carboxylic acid may not include one or more of hexanoic acid, heptanoic acid, octanoic acid, nonanoic acid, and isonanoic acid. According to some embodiments, the treated alkaline earth metal carbonate may include an amorphous hydrocarbon coating.

According to some embodiments, a composition may include a matrix material including an alkaline earth metal carbonate treated with a surface treatment composition, wherein an amount of the surface treatment composition for achieving a coating on the alkaline earth metal carbonate having a monolayer concentration ranges from 25 wt % to 75 wt % of an amount of stearic acid for achieving a coating on the alkaline earth metal carbonate having a monolayer concentration. For example, the amount of the surface treatment composition for achieving a coating on the alkaline earth metal carbonate having a monolayer concentration may range from 25 wt % to 60 wt %, from 25 wt % to 50 wt %, from 25 wt % to 40 wt %, or from 30 wt % 40 wt %, of the amount of stearic acid for achieving a coating on the alkaline earth metal carbonate having a monolayer concentration.

As used herein “alkaline earth metal carbonates” refers to Group II metals (e.g., calcium and magnesium) and to transition metals having similar chemical properties, such as, for example, zinc. According to some embodiments, the alkaline earth metal carbonate may include at least one of calcium carbonate and magnesium carbonate. According to some embodiments, the alkaline earth metal carbonate may include calcium carbonate, and the calcium carbonate may include at least one of ground calcium carbonate and precipitated calcium carbonate. The alkaline earth metal carbonates may include a carbonate of calcium, magnesium, barium, or strontium, or a carbonate of two or more alkaline earth metals, e.g., obtained from dolomite. Certain exemplary embodiments may tend to be discussed in terms of calcium carbonate and/or in relation to aspects where the calcium carbonate is processed and/or treated. The invention should not be construed as being limited to such embodiments and may be applicable to any alkaline earth metal carbonates.

Ground calcium carbonate (GCC), i.e. ground natural calcium carbonate is typically obtained by grinding a mineral source such as chalk, marble, limestone, dolomite, calcite, aragonite or precipitated calcium carbonate, which may be followed by a particle size classification step, in order to obtain a product having the desired degree of fineness. The particulate solid material may be ground autogenously, i.e. by attrition between the particles of the solid material themselves, or alternatively, in the presence of a particulate grinding medium comprising particles of a different material from the calcium carbonate to be ground (e.g. ceramic particles (e.g., silica, alumina, zirconia, aluminium silicate), plastic particles, rubber particles). Attrition can be accomplished by rubbing particles together under pressure, such as by a gas flow. In some embodiments, the attrition grinding may be performed autogenously, where the alkaline earth metal carbonate particles are ground only by other alkaline earth metal carbonate particles of the same type (e.g., calcium carbonate being ground only by calcium carbonate). In certain embodiments, the calcium carbonate is ground in a mill. The mill may include a grinding chamber, a conduit for introducing the calcium carbonate into the grinding chamber, and an impeller that rotates in the grinding chamber, thereby agitating the calcium carbonate. In certain embodiments, the calcium carbonate is dry ground, where the atmosphere in the mill is ambient air. In certain embodiments, the calcium carbonate may be wet ground.

Wet grinding of calcium carbonate involves the formation of an aqueous suspension of the calcium carbonate which may then be ground, optionally in the presence of a suitable dispersing agent. Reference may be made to, for example, EP-A-614948, the contents of which are incorporated by reference in their entirety, for more information regarding the wet grinding of calcium carbonate.

When the calcium carbonate is obtained from naturally occurring sources, it may be that some mineral impurities will inevitably contaminate the ground material. For example, naturally occurring calcium carbonate occurs in association with other minerals. Also, in some circumstances, minor additions of other minerals may be included, for example, one or more of kaolin, calcined kaolin, wollastonite, bauxite, talc or mica, could also be present. In general, however, the filler used in the invention will contain less than 5 wt.-%, preferably less than 1 wt.-% by weight of other mineral impurities.

Precipitated calcium carbonate (PCC) may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, limestone is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process, the milk of lime is contacted with soda ash to produce, by double decomposition, a precipitate of calcium carbonate and a solution of sodium hydroxide. The sodium hydroxide must be substantially completely separated from the calcium carbonate if this process is to be commercially attractive. In the third main commercial process, the milk of lime is first contacted with ammonium chloride to give a calcium chloride solution and ammonia gas. The calcium chloride solution is then contacted with soda ash to produce, by double decomposition, precipitated calcium carbonate and a solution of sodium chloride.

The process for making PCC results in very pure calcium carbonate crystals and water. The crystals can be produced in a variety of different shapes and sizes, depending on the specific reaction process that is used. The three main forms of PCC crystals are aragonite, rhombohedral and scalenohedral, all of which are suitable for use in the present invention, including mixtures thereof.

Magnesium carbonate may be produced from, for example, magnesite.

The alkaline earth metal carbonate or treated alkaline earth metal carbonate may be further subjected to an air sifter or hydrocyclone. The air sifter or hydrocyclone can function to classify the alkaline earth metal carbonate and remove a portion of residual particles greater than, for example, 20 microns. According to some embodiments, the classification can be used to remove residual particles greater than 50 microns, greater than 40 microns, greater than 30 microns, greater than 10 microns, or greater than 5 microns. According to some embodiments, the alkaline earth metal carbonate may be classified using a centrifuge, hydraulic classifier, or elutriator.

According to some embodiments, the alkaline earth metal carbonate may be subjected to size selection using a rotary or centrifugal sifter. Suitable examples of sifters include rotary sifters, such as the “K range” of centrifugal (rotary) sifters commercially available from Kek-Gardner (Kek-Gardner Ltd, Springwood Way, Macclesfield, Cheshire SK10 2ND; www.kekgardnercom), For example, the K650C is a small pilot machine with a 650 mm length of drum and the K1350 possesses a drum length of 1350 mm. The sifter may be fitted with a screen possessing a suitable mesh size. The screen may be a fine woven screen or a laser ablated screen. The screen may be made from nylon or stainless steel. Other suitable rotary (or centrifugal) sifters may be obtained from KASON (KASON Corporation, 67-71 East Willow Street, Millburn, N.J., USA; www.kason.com) and SWECO (SWECO, PO Box 1509, Florence, Ky. 41022, USA; www.sweco.com).

In a typical centrifugal sifter, material is fed into the feed inlet and redirected into the cylindrical sifting chamber by means of a feed screw. Rotating, helical paddles within the chamber continuously propel the material against a mesh screen, while the resultant, centrifugal force on the particles accelerates them through the apertures. These rotating paddles, which do not make contact with the screen, also serve to breakup soft agglomerates. Most over-sized particles and trash are ejected via the oversize discharge spout. Typically, centrifugal sifters are designed for gravity-fed applications, and for sifting in-line with pneumatic conveying systems. Suitable sifters include single and twin models and those available with belt drive or direct drive. The units may be freestanding or adapted for easy mounting on new or existing process equipment. Removable end housings allow for rapid cleaning and screen changes.

In other embodiments, the amount of coarse material present in the particulate filler may be reduced to very low values or zero by the use of a mill classifier, for example, a dynamic mill classifier or a cell mill fitted with a classifier. A mill classifier may include block rotors, blade rotors, and/or a blade classifier. Suitable examples of mill classifiers include dynamic mill classifiers and cell mills fitted with a classifier, such as those commercially available from Atritor (Atritor Limited, Coventry, West Midlands, England; www.atritor.cam), a suitable example being the multi-rotor cell mill.

In some embodiments, the alkaline earth metal carbonate (e.g. calcium carbonate such as ground calcium carbonate) disclosed herein may be free of dispersant, such as a polyacrylate. In other embodiments; a dispersant may be present in a sufficient amount to prevent or effectively restrict flocculation or agglomeration of the alkaline earth metal carbonate (e.g., ground calcium carbonate) to a desired extent, according to normal processing requirements. The dispersant may be present, for example, in levels up to about 1% by weight relative to the dry weight of the alkaline earth metal carbonate. Examples of dispersants include polyelectrolytes such as polyacrylates and copolymers containing polyacrylate species, including polyacrylate salts (e.g., sodium and aluminum optionally with a Group II metal salt); sodium hexametaphosphates, non-ionic polyol; polyphosphoric acid; condensed sodium phosphate, non-ionic surfactants, alkanolamine, and other reagents commonly used for this function.

A dispersant may be selected from conventional dispersant materials commonly used in the processing and grinding of alkaline earth metal carbonates. Such dispersants will be recognized by those skilled in this art. Dispersants are generally water-soluble salts capable of supplying anionic species, which in their effective amounts may adsorb on the surface of the alkaline earth metal carbonate particles and thereby inhibit aggregation of the particles. The unsolvated salts suitably include alkaline metal cations; such as sodium. Salvation may in some cases be assisted by making the aqueous suspension slightly alkaline. Examples of suitable dispersants also include water soluble condensed phosphates, for example, polymetaphosphate salts (general form of the sodium salts: (NaPO₃)ₓ), such as tetrasodium metaphosphate or so-called “sodium hexametaphosphate” (Graham's salt); water-soluble salts of polysilicic acids; polyelectrolytes; salts of homopolymers or copolymers of acrylic acid or methacrylic acid; or salts of polymers of other derivatives of acrylic acid, suitably having a weight average molecular mass of less than about 20,000. Sodium hexametaphosphate and sodium polyacrylate; the latter suitably having a weight average molecular mass in the range of about 1,500 to about 10,000, are preferred. In some embodiments, the production of the alkaline earth metal carbonate (e.g. calcium carbonate) includes using a grinding aid, such as propylene glycol; or any grinding aid known to those skilled in the art.

According to one aspect of the present invention, the coated particles may be present as a powder, or as a particulate composition, or as a pure dry chemical comprising substantially only particles according to the invention. According to an alternative embodiment, the coated particles according to the invention may be admixed with particles or other compositions which do not form part of the present invention.

The coating of particulate alkaline earth metal carbonates, such as calcium carbonates is well known in the art and described, for example, in WO 99/28050, or WO 01/32787 A1, the contents of both of which are incorporated by reference in their entirety.

According to one aspect of the present invention, it was found that alkaline earth metal carbonate particles having a coating of one or more aliphatic carboxylic acids, salts thereof or a mixture of one or more aliphatic carboxylic acids and one or more of their salts have advantageous properties.

According to some embodiments, the surface treatment may result in an amorphous hydrocarbon layer (e.g. a monolayer (or different concentration)) on the surface of the alkaline earth metal carbonate. Such exemplary coatings may not crystallize. According to some embodiments, the surface treatment composition is a liquid at room temperature, which renders it suitable for wet and/or low temperature coating processes, which may result in reducing the energy required to perform the surface treatment process. Alkaline earth metal carbonates treated with at least some embodiments of the surface treatment composition may exhibit higher thermal stability than similar particulates treated with other compositions, such as, for example, stearic acid, which creates a crystalline coating on the particulates. This may result in the surface treated alkaline earth metal carbonates disclosed herein as having improved compatibility with polymers and/or surfactants, which may render the treated particulates more useful for polymer processing

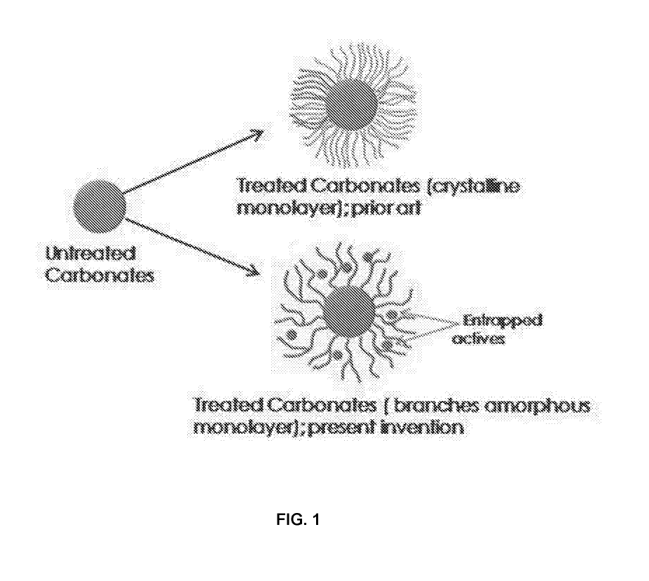

Without wishing to be bound by theory, it is believed that the surface treatment compositions disclosed herein result in the reduced carboxylic add functional group content reducing the ionic nature and hence static charging of the surface treated solid particulates. The amorphous nature of the surface coating is believed to reduce the potential for excess acid of the surface treatment composition to insert tail first into the coating. As a result, it is believed that unbound acid will be readily extractable. In contrast, coatings formed with treatment of stearic acid have a large component of thermally available acid that is released. As shown in FIG. 1, according to embodiments disclosed herein, the amorphous monolayer concentration of the surface treatment composition formed on carbonate particles may also provide a higher free volume at the surface and may render the coating suitable to insertion of biologically- and/or agriculturally-active compositions, such as, for example, herbicides, fungicides, etc. The amorphous coating may improve interaction with such polymer matrices.

The aliphatic carboxylic acids for use in the present invention may for example be fatty acids, such as for example C₈ to C₃₂-fatty acids. The C₈ to C₃₂-fatty acids these may be C₈ to C₂₄-fatty acids, or C₁₀ to C₁₈-fatty acids, or preferably C₁₂ to C₁₈-fatty acids, such as for example stearic acid, palmitic acid, myristic acid, or lauric acid. These fatty acids may alternatively be hydroxylated fatty acids, such as mono-, bi- tri- or multi-hydroxylated fatty acids. For example, the hydroxylated fatty acids may be selected from hydroxylated stearic acid, hydroxylated palmitic acid, hydroxylated myristic acid, or hydroxylated lauric acid, such as for example the ω-hydroxylated derivatives, or the 6-hydroxylated derivatives, the 8-hydroxylated derivatives, the 10-hydroxylated derivatives, the 12-hydroxylated derivatives, the 14-hydroxylated derivatives, or the 16-hydroxylated derivatives, as the case may be.

With regards to the aliphatic carboxylic acid salts, they may be derived from any of the aliphatic carboxylic acids as defined hereabove. The salts may be mono-, bi or trivalent salts of aliphatic carboxylic acids, such as the lithium, sodium salts, potassium salts, beryllium salts, calcium salts, magnesium salts, or aluminium salts, or any mixtures thereof.

The aliphatic carboxylic acids for use in the present invention may also be cycloaliphatic acids. According to some embodiments, a ring of the cycloaliphatic acid may include at least one of a five carbon ring and a six carbon ring, such as, for example, a combination of both five carbon ring and six carbon ring cycloaliphatic acids. According to some embodiments, the cycloaliphatic acid may include naphthenic acid. According to some embodiments, the cycloaliphatic acid may include one or more of 7-(3-butylcyclopentyl)heptanoic acid, 7-(3-propylcyclopentyl)heptanoic acid, 7-(3-ethylcyclopentyl) heptanoic acid, 6-(1-butyloctahydro-1 H-inden-5-yl) hexanoic acid, 6-(4-butyloctahyd ropentalen-2-yl)hexanoic acid, 7-(5-butyldodecahydro-1H-phenalen-2-yl)heptanoic acid, etc.

The aliphatic carboxylic acids for use in the present invention may also be branched carboxylic acids, which may, for example, include at least one of 2-ethylhexanoic acid, isostearic acid, alkyl-substituted cyclohexane carboxylic acid, and crystalline diacids. For example, the at least one alkyl chain may form a branch of the branched carboxylic acid. According to some embodiments, the branched carboxylic acid may not include one or more of hexanoic acid, heptanoic acid, octanoic acid, nonanoic acid, and isonanoic acid.

According to one aspect of the present invention, it was found that alkaline earth metal carbonate particles, such as calcium carbonate particles, having a coating of 12-hydroxystearic acid have advantageous properties. Such coated particles have not been specifically described nor used previously.

According to some embodiments, the surface treatment composition may comprise from 0.05 wt % to 5 wt % relative to the total weight of the composition. For example, the surface treatment composition may comprise from 0.1 wt % to 5 wt %, or from 0.1 wt % to 4 wt %, or from 0.1 wt % to 3 wt %, or from 0.1 wt % to 2 wt %, or from 0.1 wt % to 1.0 wt %, or from 0.1 wt % to 0.9 wt %, or from 0.1 wt % to 0.8 wt %, or from 0.1 wt % to 0.7 wt % or from 0.1 wt % to 0.6 wt %, or from 0.1 wt % to 0.5 wt %, or from 0.1 wt % to 0.4 wt %, or from 0.2 wt % to 0.6 wt %, or from 0.1 wt % to 0.7 wt % relative to the total weight of the composition. According to some embodiments, the surface treatment composition may comprise less than a monolayer concentration. According to some embodiments, the surface treatment composition may comprise at least a monolayer concentration, for example, greater than a monolayer concentration. “Monolayer concentration,” as used herein, refers to an amount sufficient to form a monolayer on the surface of the alkaline earth metal carbonate particles. Such values will be readily calculable to one skilled in the art based on, for example, the surface area of the particles. According to some embodiments, the filler composition may comprise less than about 10% free surface treatment composition relative to a monolayer concentration, such as for example, less than about 5% free surface treatment composition relative to a monolayer concentration,

It is particularly useful to provide the ground or precipitated alkaline earth metal carbonate particles with a carboxylic acid monolayer, such as a 12-hydroxystearic acid monolayer. A monolayer on a particle is defined as a layer over the whole surface of the particle, which is just one molecule thick. Techniques for providing monolayer coatings and determining a “monolayer concentration” or a “monolayer equivalent amount” of a coating are known to the skilled person and have been previously described.

According to one aspect of the invention, the monolayer of carboxylic acid, such as a monolayer of 12-hydroxystearic acid is formed by reaction of the acid group of the carboxylic acid, such as the 12-hydroxystearic acid, with the basic carbonate on the surface of the alkaline earth metal carbonate particle, such as a calcium carbonate particle. Such a chemisorbed coating is known to be stable and leaves a free hydroxyl group of the chemisorbed 12-hydroxystearic acid.

According to one aspect of the present invention, the coated particles consist of substantially only the alkaline earth metal carbonate particle and the carboxylic acid coating, such as a 12-hydroxystearic acid coating (bare any inevitable mineral impurities as described above, or any artefacts from the synthesis or decomposition products from the carboxylic acid, such as the 12-hydroxystearic acid, or the alkaline earth metal carbonate, such as the calcium carbonate). The advantageous effects may be more pronounced when the “pure” product is used.

According to alternative aspects of the present invention, the particles may comprise further coating materials, such as for example other fatty acids, such as for example stearic acid or palmitic acid, fatty acid salts, such as for example stearates or palmitates, or their hydroxylated analogues. These may be applied as mixed coatings together with the carboxylic acid coating, such as the 12-hydroxystearic acid coating, or as separate coatings, either below or above the carboxylic acid coating, such as the 12-hydroxystearic acid coating. According to these alternative aspects, the carboxylic acid coating, such as the 12-hydroxystearic acid coating, shall constitute at least 10 wt.-%, or at least 25 wt.-%, or at least 40 wt.-%, or at least 50 wt.-%, or at least 60 wt.-%, or at least 75 wt.-%, or at least 90 wt.-%, or at least 95 wt.-%, or at least 98 wt.-%, or at least 99 wt.-%, or at least 99.5 wt.-% of the total weight of the coating on the particle.

According to some embodiments, a treated alkaline earth metal carbonate may be undercoated with a surface treatment. As used herein, the term “undercoated” or “undercoating” refers to a surface treatment that includes less than a monolayer concentration of the surface treatment of a treated alkaline earth metal carbonate. For example, the undercoated alkaline earth metal carbonate may include a surface treatment that includes from about 50% to about 95% of a monolayer concentration, such that from about 5% to about 50% of the surface of the alkaline earth metal carbonate is not reacted with the surface treatment. According to some embodiments, the undercoating may range from about 50% to about 95% of a monolayer concentration, such as, for example, from about 70% to about 95%, from about 80% to about 95%, from about 85% to about 95%, from about 90% to about 95%, from about 80% to about 90%, or from about 85% to about 90% of a monolayer concentration. The undercoated alkaline earth metal carbonate may be prepared by the same methods as a treated alkaline earth metal carbonate, except that the concentration of surface treatment composition is reduced to create the desired level of undercoating.

According to one aspect of the present invention, the alkaline earth metal carbonate particle, such as the calcium carbonate particle, prior to coating, has a particle size distribution such that the d₅₀ is from 0.05 μm to 20 μm, or from 0.05 μm to 10 μm.

According to some embodiments, the treated alkaline earth metal carbonate may be characterized by a mean particle size (d₅₀ value, defined as the size at which 50 percent of the calcium carbonate particles have a diameter less than or equal to the stated value. In some embodiments, the treated alkaline earth metal carbonate may have a d₅₀ in the range from about 0.1 micron to about 50 microns, such as, for example, in the range from about 0.1 micron to about 30 microns, from about 0.1 micron to about 20 microns, from about 0.1 micron to about 10 microns, from about 0.1 micron to about 5 microns, from about 0.1 micron to about 3 microns, from about 0.1 micron to about 2 microns, from about 0.1 micron to about 1 micron, from about 0.5 microns to about 2 microns, from about 1 micron to about 5 microns, from about 5 microns to about 20 microns, or from about 5 microns to about 10 microns.

According to some embodiments, the treated alkaline earth metal carbonate may be characterized by a top cut size (d₉₈) value, defined as the size at which 98 percent of the alkaline earth metal carbonate particles have a diameter less than or equal to the stated value. In some embodiments, the treated alkaline earth metal carbonate may have a d₉₈ in the range from about 2 microns to about 100 microns, such as, for example, in the range from about 5 microns to about 50 microns, from about 2 micron to about 20 microns, or from about 5 microns to about 20 microns.

Unless otherwise stated, particle size properties referred to herein for the particulate materials are as measured in a well known manner by sedimentation of the particulate filler or material in a fully dispersed condition in an aqueous medium using a Sedigraph 5100 machine as supplied by Micromeritics Instruments Corporation, Norcross, Ga., USA (telephone: +17706623620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₀ is the value determined in this way of the particle e.s.d at which there are 50 wt.-% of the particles which have an equivalent spherical diameter less than that d₅₀-value.

According to one aspect of the present invention, the mass ratio of alkaline earth metal carbonate, such as calcium carbonate, to carboxylic acid, such as 12-hydroxystearic acid, is in the range of 1000:1 to 1:1. The lower the ratio is, the more carboxylic acid coating, such as 12-hydroxystearic acid, is present compared to the alkaline earth metal carbonate, or, in other words, the heavier the coating is. In general the range will be lower for very fine particles, and higher for coarser particles. Accordingly, the amount of coating may be adapted to the particle size.

According to one aspect of the present invention, the BET surface area of the alkaline earth metal carbonate particles, such as the ground calcium carbonate particles, prior to application of the coating may be in the range of 0.4 to less than 50 m²·g⁻¹. As used herein, the BET surface area of the alkaline earth metal carbonate particles was measured by using a ‘Tristar’ Surface Area and Porosimetry Analyzer from Micromeritics.

One aspect of the present invention concerns the use of aliphatic carboxylic acid (salt) coated alkaline earth metal carbonate particles according to the present invention as fillers in plastic materials. For example, the carboxylic acid (salt) coated alkaline earth metal carbonate particles, such as 12-hydroxystearic acid coated ground or precipitated calcium carbonate particles, may be employed as filler in polyurethane. Polyurethanes are generally formed by reaction of isocyanates with polyols.

As used in this disclosure, the terms “polymer,” “resin,” “polymeric resin,” and derivations of these terms may be used interchangeably. According to some embodiments, the polymeric resin is chosen from conventional polymeric resins that provide the properties desired for any particular yarn, woven product, non-woven product, film, mold, or other applications.

According to some embodiments, the polymeric resin may be a thermoplastic polymer, including but not limited to, a polyolefin, such as, for example, polypropylene and polyethylene homopolymers and copolymers, including copolymers with 1-butene, 4-methyl-1-pentene, and 1-hexane; polyamides, such as nylon; polyesters; and copolymers of any of the above-mentioned polymers. Examples of thermoplastic polymers may also include polyolefin homopolymers or copolymers (e.g., low density or high density polyethylenes, linear polyethylenes, polypropylenes, ethylene-propylene copolymers, ethylene(vinyl acetate) copolymers, and ethylene- (acrylic acid) copolymers, halogenated polyethylenes (such as chlorinated polyethylene), polybutene, polymethylbutene, polyisobutylene, polystyrenes and polystyrene derivatives (e.g., SB, ABS, SA, and SBS rubbers), PVCs, polycarbonates, polysulphones, polyether sulphones, PEEK, saturated polyesters (e.g., polyethylene terephthalates and/or polybutylene terephthalates), and polyphenylene oxides and blends, mixtures or copolymers containing these species.

According to some embodiments, the polymeric resin may include an isotropic semi-crystalline polymer. An isotropic semi-crystalline polymer may be melt-processable, melting in a temperature range that makes it possible to spin the polymer into fibers in the melt phase without significant decomposition. Exemplary isotropic semi-crystalline polymers may include, but are not limited to, poly(alkylene terephthalates), poly(alkylene naphthalates), poly(arylene sulfides), aliphatic and aliphatic-aromatic polyamides, polyesters comprising monomer units derived from cyclohexanedimethanol and terephthalic acid, poly(ethylene terephthalate), poly(butylene terephthalate), poly(ethylene naphthalate), poly(phenylene sulfide), and poly(1,4-cyclohexanedimethanol terephthalate), wherein the 1,4-cyclohexanedimethanol may be a mixture of cis- and trans- isomers, nylon-6, and nylon-66.

According to some embodiments, the polymeric resin may include a semi-crystalline polymer polyolefin, including but not limited to, semi-crystalline polyethylene and polypropylene. According to some embodiments, the polymeric resin may include an extended chain polyethylene having a high tensile modulus, made by the gel spinning or the melt spinning of very or ultrahigh molecular weight polyethylene.

According to some embodiments, isotropic polymers that cannot be processed in the melt may also be used as the polymeric resin. For example, the isotropic polymer may include RAYON®, cellulose acetate, polybenzimidazole, poly[2,2′-(m-phenylene)-5,5′-bibenzimidazole]. According to some embodiments, isotropic polymers may be dry spun using acetone; N,N′-dimethylacetamide; or polar aprotic solvents, including but not limited to N-methylpyrrolidinone as a solvent.

According to some embodiments, the polymeric resin may include a liquid crystalline polymer (LCP). LCPs may generally produce fibers with high tensile strength and/or modulus. According to some embodiments, the LCP may be processable in the melt (i.e., thermotropic). According to some embodiments, LCPs that exhibit liquid crystalline behaviour in solution may be blended with a hard filler, and then wet or dry spun to yield monofilament fibers. According to some embodiments, the liquid crystalline polymer may include any aromatic polyamide that is soluble in polar aprotic solvents, including, but not limited to, N-methylpyrrolidinone, and that can be spun into monofilament fibers. According to some embodiments, an aromatic polyamide made from p-phenylenediamine and terephthalic acid (including, but not limited to, polymers sold under the KEVLAR® trademark) can be filled and wet spun to yield monofilament fibers. According to some embodiments, the liquid crystalline polymer may not be liquid crystalline under some or all of a given condition or set of conditions, but may still yield high modulus fibers. According to some embodiments, the liquid crystalline polymer may exhibit lyotropic liquid crystalline phases at some concentrations and in some solvents, but isotropic solutions at other concentrations and/or in other solvents.

According to some embodiments, the liquid crystalline polymers (LCPs) may include thermotropic LCPs. Exemplary thermotropic LCPs include, but are not limited to, aromatic polyesters, aliphatic-aromatic polyesters, aromatic poly(esteramides), aliphatic-aromatic poly(esteramides), aromatic poly(esterimides), aromatic poly(estercarbonates), aromatic polyamides, aliphatic-aromatic polyamides and poly(azomethines). According to some embodiments, the thermotropic LCPs are aromatic polyesters and poly(esteramides) that form liquid crystalline melt phases at temperatures less than about 360° C. and include one or more monomer units derived from the group consisting of terephthalic acid, isophthalic acid, 1,4-hydroquinone, resorcinol, 4,440 -dihydroxybiphenyl, 4,4′-biphenyldicarboxylic acid, 4-hydroxybenzoic acid, 6-hydroxy-2-naphthoic acid, 2,6-naphthalenedicarboxylic acid, 2,6-dihydroxynaphthalene, 4-aminophenol, and 4-aminobenzoic acid. According to some embodiments, the aromatic groups may include substituents that do not react under the conditions of the polymerization, such as lower alkyl groups having 1-4 carbons, aromatic groups, F, Cl, Br, and I.

According to some embodiments, the LCPs may have monomer repeat units derived from 4-hydroxybenzoic acid and 6-hydroxy-2-naphthoic acid in a ratio in the range from about 15:85 to about 85:15 on a mole basis, such as, for example, in the range from about 27:73 to about 73:27 on a mole basis, or from about 40:60 to about 60:40 on a mole basis. Additional polymeric resins, such as those described in International Publication No. WO 2009/094321 may also be used.

According to some embodiments, the treated alkaline earth metal carbonates may be used as a filler for a polymer product, such as, for example, a filler for a polymer fiber or film (e.g. breathable film). For example, the treated alkaline earth metal carbonate may be used as a filler in a raffia tape or woven raffia packaging (e.g. polypropylene raffia). For example, the treated alkaline earth metal carbonate may be used as a filler in synthetic paper (paper made partly or completely from synthetic polymer and having the properties of traditional paper such as folding and printing, but does not tear, puncture or absorb water as easily). According to some embodiments, monofiliment fibers, may be produced according to any appropriate process or processes now known to the skilled artisan or hereafter discovered. A monofilament fiber may include the production of a continuous monofilament fiber of at least one polymeric resin and at least one filler. Exemplary techniques include, but are not limited to, melt spinning, dry spinning, wet spinning, spinbonding, or meltblowing processes. Melt spinning may include an extrusion process to provide molten polymer mixtures to spinneret dies. According to some embodiments, monofilament fibers may be produced by heating the polymeric resin to at least about its melting point as it passes through the spinneret dies.

The treated alkaline earth metal carbonate filler may be incorporated into the polymeric resin using any method conventionally known in the art or hereafter discovered. For example, treated alkaline earth metal carbonate may be added to the polymeric resin during any step prior to extrusion, for example, during or prior to the heating step or as a “masterbatch” in which the polymeric resin and the filler are premixed and optionally formed into granulates or pellets, and melted or mixed with additional virgin polymeric resin before extrusion of the fibers. According to some embodiments, the virgin polymeric resin may be the same or different from the polymeric resin containing the filler. The molten polymer may then be continuously extruded through at least one spinneret to produce long filaments. The extrusion rate may vary according to the desired application, and appropriate extrusion rates will be known to the skilled artisan. Extrusion of the filled polymer from the spinnerets may be used to create, for example, a non-woven facbric.

According to some embodiments, a polymeric film may be created from the molten filled polymer according to methods known in the art or hereinafter discovered. For example, melt compounding may also be used to extrude films, tubes, shapes, strips, and coatings onto other materials, injection molding, blow molding, or casting, and thermoforming and formation of tubes or pipes (e.g., such as when the polymer is a PVC polymer). The melt compounding may, for example, be carried out in a suitable compounder or screw extruder. A thermoplastic material to be compounded may suitably be in a granular or pelletized form. The temperature of the compounding and molding, shaping, or extrusion processes will depend upon the thermoplastic material being processed and materials incorporated therein. The temperature will be above the softening point of the thermoplastic material.

Without wanting to be bound by theory, it is thought that the free hydroxyl group on the coating of the coated calcium carbonate particles reacts to covalently bond with isocyanate to form a bond between the polymer system and the mineral filler. In other terms, the coated calcium carbonate particles according to the present invention may be admixed with a polyol component of a 2-component system wherein the second component is an isocyanate. Upon reaction of the components for forming a polyurethane, the polymerisation may occur concurrently and partially in competition with the covalent bonding of the hydroxyl group with the isocyanate leading to improved mechanical properties of the finished product.

In fact, it was found that the obtained product has improved scratch resistance, better thermal conductivity during curing and a reduced shrinkage, when compared to equivalent compositions comprising uncoated GCCs or PCCs, or GCCs or PCCs coated with other organic or inorganic compositions. The most advantageous effect were found with 12-hydroxystearic acid coated GCC and PCC.

A further aspect of the present invention concerns the use of aliphatic carboxylic acid (salt) coated alkaline earth metal carbonate particles according to the present invention as a component in offset ink compositions, of any process colour. For example, the carboxylic acid (salt) coated calcium carbonate particles, such as 12-hydroxystearic acid coated ground or precipitated calcium carbonate particles may be used as a component in offset ink compositions.

The offset printing technique employs a flat image carrier on which the image to be printed obtains ink from ink rollers, while the non-printing area attracts a water-based film called “fountain solution”, keeping the non-printing areas ink-free. Ink/water balance is an extremely important part of offset printing. If ink and water are not properly balanced, the press operator may end up with many different problems affecting the quality of the finished product, such as emulsification. This leads to scumming, catchup, trapping problems, ink density issues and in extreme cases the ink not properly drying on the carrier. It was found that the resulting inks using the coated calcium carbonates according to the present invention showed improved water/ink balance and a superior bleed resistance compared to offset inks comprising, when compared to equivalent compositions comprising uncoated GCCs or PCCs, or GCCs or PCCs coated with other organic or inorganic compositions. The most advantageous effect were found with 12-hydroxystearic acid coated GCC and PCC.

According to some embodiments, the surface treatment may be performed as a dry coating process. According to some embodiments, the surface treatment may be performed as a wet coating process, for example, with from 60 wt % to 90 wt % solids, such as, for example, from 65 wt % to 85 wt % solids, or from 70 wt % to 80 wt % solids.

According to some embodiments, a method for surface treating alkaline earth metal carbonates may include providing an alkaline earth metal carbonate and combining a surface treatment composition with the alkaline earth metal carbonate to form a combination of the alkaline metal earth carbonate and the surface treatment composition. The method may further include heating the combination to a temperature of less than 150° C. or less than 95° C. to form a coating of the surface treatment composition on the alkaline earth metal carbonate. For example, the combination may be heated to a temperature ranging from greater than 15° C. to less than 150° C. or from greater than 15° C. to less than 95° C., from greater than 20° C. to less than 95° C., from greater than 25° C. to less than 95° C., from greater than 25° C. to less than 70° C., or from greater than 25° C. to less than 60° C., to form a coating of the surface treatment composition on the alkaline earth metal carbonate.

According to some embodiments, the alkaline earth metal carbonate may be surface treated in a treatment vessel containing a water-dry atmosphere in which the surface treatment composition is in a liquid (e.g., droplet) and/or vapour form. For example, alkaline earth metal carbonate (e.g. calcium carbonate) may be treated by exposing the alkaline earth metal carbonate to the surface treatment composition as disclosed herein.

The mixture may be blended at a temperature sufficient for at least a portion of the surface treatment composition to react with at least a portion of the alkaline earth metal carbonate. For instance, the mixture may be blended at a temperature sufficient such that at least a portion of the surface treatment composition may coat at least a portion of the alkaline earth metal carbonate particulates.

According to some embodiments, the alkaline earth metal carbonate may be treated by exposing the surface of the alkaline earth metal carbonate to the surface treatment composition in the reaction vessel at a temperature at which surface treatment composition is in a fluid or vaporized state. For example, the temperature may be in the range from about 0° C. to about 150° C., such as, for example, from about 25° C. to about 95° C. The temperature selected in the atmosphere of the treatment vessel should provide sufficient heat to ensure melting and good mobility of the molecules of the surface treatment composition, and therefore, good contacting of and reaction with the surface of the alkaline earth metal carbonate particles. In some embodiments, a mixture of the alkaline earth metal carbonate and surface treatment composition may be blended at a temperature high enough to melt the surface treatment composition.

Surface treating the alkaline earth metal carbonate may be carried out in a heated vessel in which a rapid agitation or stirring motion is applied to the atmosphere during the reaction of the surface treatment composition and with the alkaline earth metal carbonate, such that the surface treatment composition is well-dispersed in the treatment atmosphere. The agitation should not be sufficient to alter the surface area of the alkaline earth metal carbonate because such an alteration may change the required surface treatment composition concentration to create, for example, a monolayer concentration. The treatment vessel may include, for example, one or more rotating paddles, including a rotating shaft having laterally extending blades including one or more propellers to promote agitation and deagglomeration of the carbonate and contacting of the carbonate with the surface treatment composition.

According to some embodiments, a treated alkaline earth metal carbonate may be prepared by combining (e.g., blending) the carbonate with the surface treatment composition and water at room temperature in an amount greater than about 0.1% by weight relative to the total weight of the mixture (e.g., in the form of a cake-mix). The mixture may be blended at a temperature sufficient for at least a portion of the surface treatment composition to react (e.g., sufficient for a majority of the surface treatment composition to react) with at least a portion of the surface of the alkaline earth metal carbonate. For instance, the mixture may be blended at a temperature sufficient such that at least a portion of the surface treatment composition may coat the surface of the alkaline earth metal carbonate in a monolayer concentration.

According to some embodiments, an alkaline earth metal carbonate, such as calcium carbonate, may be combined (e.g., blended) at room temperature with the surface treatment composition and water in an amount greater than about 1% by weight relative to the total weight of the mixture (e.g., in the form of a cake-mix). For example, according to some embodiments, the mixture may be blended at a temperature sufficient for at least a portion of the surface treatment composition to react. For example, the mixture may be blended at a temperature sufficient, such that at least a portion of the surface treatment composition may coat at least a portion of the alkaline earth metal carbonate (e.g., the surface of the alkaline earth metal carbonate).

It should be noted that the present invention may comprise any combination of the features and/or limitations referred to herein, except for combinations of such features which are mutually exclusive. The foregoing description is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims.

### EXAMPLES

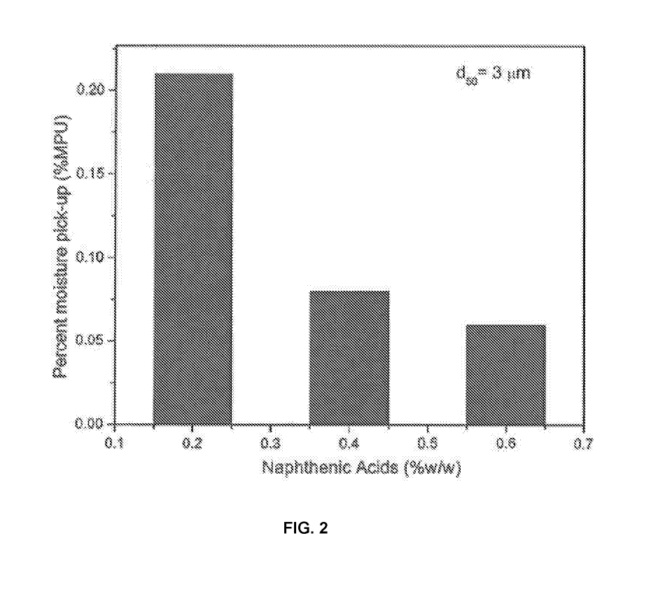

A sample of alkaline earth metal carbonate particulate having a median particle size (d₅₀) of 3 microns (μm) and a specific surface area 3.0 m²/g measured via a nitrogen BET method, was subjected to an exemplary surface treatment process. A 2000 gram sample of carbonate slurry formed from the carbonate particulate sample (70% solids) was added to a pepenmeir blender, followed by an addition of a known amount of dry powder of the same carbonate particulate to bring the solids content up to 80% and mixed for 5 minutes. A varying amount of exemplary naphthenic acids (0.2-0.6) were added to the carbonate particulates and blended further for 15 minutes. Thereafter, the treated carbonate cake was dried at 100° C. for 15 hours and re-ground in the blender. Surface modification of treated carbonate particulates was characterized with thermal gravimetric analysis (TGA) to estimate the percent weight loss with increasing temperature and correlated to reacted acid. The TGA analysis showed that the coated carbonate does not show any weight loss below 250° C., and the reacted acid varied from 0.16% to 0.40%. Further, the percent moisture pick-up (%MPU) at 25° C., 85% RH and for 24 hours was measured, and a decrease in % MPU was observed with increase in reacted acid, and it varied from 0.20% to 0.06% (see FIG. 2), which is comparable to the similar carbonate particles treated with ammonium stearate. In a similar experiment, a carbonate particulates of 70% solids content showed a similar level of moisture pick-up.

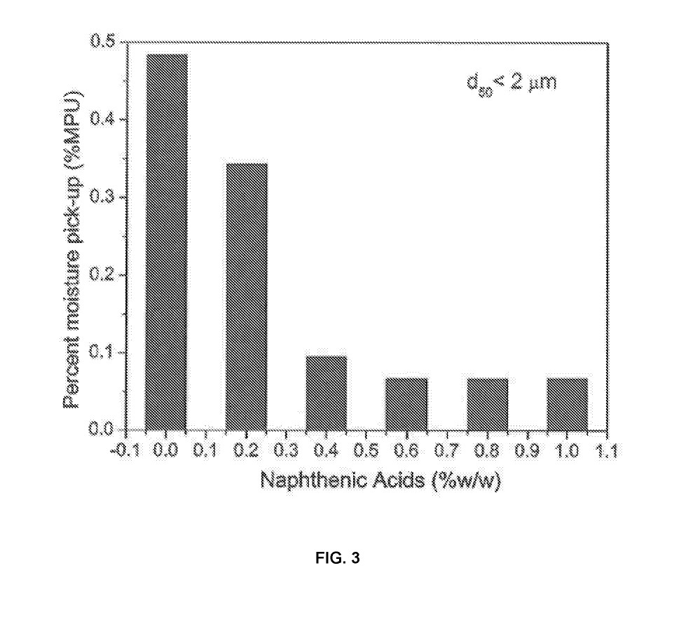

In a second example, a dry coating of small-sized carbonate particulates (having a d50 of 1.78 microns) and a specific surface area of 4.0 to 4.5 m²/g was performed. A 2000 gram sample of carbonate particulates was mixed with varying amounts of exemplary naphthenic acids. The results showed that the percent moisture pick-up decreases with increase in acid concentration before it reaches plateau at 0.6% (w/w) of naphthenic acid (see FIG. 3).

Other embodiments will be apparent to those skilled in the art from consideration of the specification and practice of the embodiments disclosed herein. It is intended that the specification and examples be considered as exemplary only.

1. A coated particle comprising an alkaline earth metal carbonate particle and a coating, wherein the coating, comprises one or more aliphatic carboxylic acids, salts thereof, or a mixture of one or more aliphatic carboxylic acids and one or more of their salts

2. A coated particle according to claim 1, wherein
the one or more aliphatic carboxylic acids is one or more cycloaliphatic acids, and/or
the one or more aliphatic carboxylic acids is one or more branched carboxylic acids having at least one alkyl chain, and/or
the one or more aliphatic carboxylic acids is one or more fatty acids, or one or more hydroxylated fatty acids.

3. A coated particle according to claim 1, wherein the alkaline earth carbonate particle is a ground calcium carbonate (GCC), a wound magnesium carbonate, or another ground alkaline earth metal carbonate, or a precipitated calcium carbonate (PCC), a precipitated magnesium carbonate, or another precipitated alkaline earth metal carbonate.

4. A coated particle according to claim 1, wherein
the said coating is a monolayer coating,
the said coating is present in a less than a monolayer concentration, or
the said coating is present in at least a or greater than a monolayer concentration.

5. A coated particle according to claim 1, wherein the coating constitutes from 0.05 wt.-% to 5 wt.-% of the total weight of the particle including the coating.

6. A coated particle according to claim 5, wherein said one or more fatty acids or hydroxylated fatty acids is selected from the group of one or more C₈ to C₃₂-fatty acids and hydroxylated C₈ to C₃₂-fatty acids.

7. A coated particle according to claim 6, wherein said one or more fatty acids or hydroxylated fatty acids is selected from the group consisting of stearic acid, palmitic acid, myristic acid, lauric acid, their hydroxylated derivatives and any mixtures thereof.

8. A coated particle according to claim 1, wherein said one or more aliphatic carboxylic acids is one or more cycloaliphatic acids comprising at least one of a five carbon ring and a six carbon ring, and a combination of both five carbon ring and six carbon ring cycloaliphatic acids.

9. A coated particle according to claim 8, wherein the cycloaliphatic acid comprises at least one of naphthenic acid, 7-(3-butylcyclopentyl)heptanoic acid, 7-(3-propylcyclopentyl)heptanoic acid, 7-(3-ethylcyclopentyl)heptanoic acid, 6-(1-butyloctahydro-1H-inden-5-yl)hexanoic acid, 6-(4-butyloctahydropentalen-2-yl)hexanoic acid, and 7-(5-butyldodecahydro-1H-phenalen-2-yl)heptanoic acid.

10. A coated particle according to claim 1, wherein said one or more aliphatic carboxylic acids is one or more branched carboxylic acids having at least one alkyl chain, comprising at least one of 2-ethylhexanoic acid, isostearic acid, alkyl-substituted cyclohexane carboxylic acid, and crystalline diacids,

11. A coated particle according to claim 1, wherein the said one or more aliphatic carboxylic acids is one or more optionally hydroxylated stearic acids.

12. A coated particle according claim 1, consisting of alkaline earth metal carbonate and one or more aliphatic carboxylic acids, one or more salts thereof, or a mixture of one or more aliphatic carboxylic acids and one or more of their salts.

13. A coated particle according to claim 1, wherein no other coatings are present on the particle.

14. A coated particle according to claim 1, wherein the said coating is applied directly onto the particle surface.

15. A coated particle according to claim 1, wherein a further coating is present.

16. A coated particle according to claim 15, wherein
said further coating is present between the said coating and the particle, said further coating is present on top of the said coating applied directly onto the particle surface, or
said further coating is present both between the said coating and the particle and on top of the said coating.

17. A coated particle according to claim 1 having a d₅₀ between 0.05 μm and 20 μm.

18. A coated particle according to claim 1, wherein the mass ratio of alkaline earth metal carbonate to aliphatic carboxylic acid is from 1000:1 to 1:1.

19. A coated particle according to claim 1 having a BET surface area prior to application of the coating of 0.4 to less than 50 m²·g⁻¹.

20-33. (canceled)

34. A composition comprising the coated particle of claim 1.

35. The composition of claim 34, wherein the composition comprises a polymer or a plastic.

36. The composition of claim 34, wherein the composition is an offset ink.

37. The composition of claim 34, wherein the composition is a filler material.
